(19) United States
(12) Patent Application Publication
(10) Pub. No.: US 2005/0118984 A1
(43) Pub. Date: Jun. 2, 2005

(54) Receiving, displaying, and recording apparatus

(76) Inventors: Hitoshi Akiyama, Yokohama (JP); Kenji Wada, Yokohama (JP)

Correspondence Address: MCDERMOTT WILL & EMERY LLP, 600 13th Street, N.W., Washington, DC, 20005-3096, US

(21) Appl. No.: 10/929,761

(22) Filed: Aug. 31, 2004

(30) Foreign Application Priority Data
Nov. 27, 2003 (JP) 2003-396501

(51) Int. Cl. H04M 11/04

(52) U.S. Cl. 455/404.2

(57) ABSTRACT

When an emergency broadcast is made, the emergency broadcast channel must be forcedly switch-selected. If an emergency broadcast is detected while a recorder is recording a received signal, the received signal output to the recorder is forcedly switched to the emergency broadcast channel; and the channel originally intended to be recorded becomes unrecordable. To avoid this recording of the emergency broadcast, a plurality of receiving systems are each formed of a tuner, demodulator, demultiplexer, and decoder. When an emergency broadcast is detected, the receiving system receiving a signal for recording continues the tuning and demodulation as before; and another receiving system tunes in to the emergency broadcast channel for displaying the channel.

### BACKGROUND OF THE INVENTION

The present invention relates to a receiving apparatus for receiving a digital broadcast radio signal or a high-priority signal and to a video displaying apparatus and a recording apparatus using the receiving apparatus. More particularly, it relates to a receiving apparatus for receiving an emergency broadcast transmitted from a broadcasting station.

A digital broadcast receiving apparatus for receiving digital broadcasts using transmission media such as terrestrial wave, cable, and satellite selects an optional broadcast wave from a plurality of broadcast waves with a tuner, selects an optional channel from a plurality of channels included in the selected broadcast wave by demultiplexing, takes out a digital signal of the selected channel, and outputs video and audio signals by decoding the digital signal.

In digital broadcasting, it is possible, in an emergency, to transmit a displayable character message stream and a displayable video and audio stream with such a stream multiplexed on the transport stream. On the side of a receiving apparatus, it is possible to detect that an emergency message included in the digital broadcast is being broadcast and, by extracting the data for the emergency broadcast, to have the data displayed superimposed on the received video, or to switch the channel for decoding and displaying over to the stream for the emergency broadcast.

There are established regulations for emergency broadcast in18 2001: Emergency Alert Message for Cable as a US standard for digital cable broadcasting. When it is detected that an emergency broadcast is being made, receiving apparatus conforming to this standard must perform the procedure to tune in to the emergency broadcast channel without fail.

In receiving apparatus, it is generally practiced to output a received digital signal or an analog signal obtained by decoding to a recorder for recording the signal. Further, there is devised a method causing, when an emergency broadcast is started, an apparatus while recording a signal to preferentially display the emergency broadcast. (Refer, for example, to Japanese Laid-open Patent Publication No. 2003-244600.)

Also, there is disclosed a system in which an apparatus is provided with two tuning sections and the apparatus is allowed to automatically display an emergency alarm by making use of teletext. (Refer, for example, to Japanese Laid-open Patent Publication No. H10-145751.)

### SUMMARY OF THE INVENTION

In prior art, when the received channel has to be forcedly switched to an emergency broadcast at the time of an emergency broadcast as specified in the above mentioned US digital cable broadcast standard, the displayed screen is switched to an emergency broadcast channel and, at the same time, a received signal output to a recorder is forcedly switched to the emergency channel following detection of an emergency broadcast and subsequent switching of the tuned channel to the emergency broadcast channel. Therefore, video recorded in a recorder is switched to the emergency broadcast channel upon detection of the emergency broadcast. The emergency broadcast channel is transmitted for the purpose of being received and watched while it is transmitted, and hence its being recorded in a recorder is meaningless. It is, however, desired by the user of the receiver and recorder that originally intended recording of the channel be continued, while the emergency broadcast is received and displayed.

In view of the abovementioned situations, it is an object of the present invention to provide a digital broadcast receiving apparatus capable of ceaselessly recording a channel originally intended by the user to record, while an emergency broadcast channel is received and displayed.

An apparatus comprises a first and a second receiver for receiving different physical channels, a first and a second output unit for outputting one of the signals received by the first receiver and the second receiver, and a detector for detecting presence of an emergency broadcast. When an emergency broadcast is detected by the detector, the first receiver and the first output unit are controlled such that the physical channel over which the emergency broadcast is broadcast is received by the first receiver and output from the first output unit, while the second receiver and the second output unit are controlled such that one of the first physical channel having been received by the first receiver and the second physical channel having been received by the second receiver before the emergency broadcast was detected is received by the second receiver and output from the second output unit.

Further, the second receiver and the second output unit are controlled, when an emergency broadcast is detected by the detector, such that the physical channel signal having been output from the second output unit before the emergency broadcast was detected is received by the second receiver and put out by the output unit.

The present invention provides improved operability for the user.

### BRIEF DESCRIPTION OF THE DRAWINGS

These and other features, objects and advantages of the present invention will becomes more apparent from the following description when taken in conjunction with the accompanying drawings wherein:

FIG. 1 is a drawing explanatory of a method of practicing a receiving apparatus according to the present invention. (First embodiment.)

FIG. 2 is a drawing explanatory of a method of practicing a receiving apparatus according to the present invention. (Second embodiment.)

FIG. 3 is a drawing explanatory of a method of practicing a receiving apparatus according to the present invention. (Third embodiment.)

### DETAILED DESCRIPTION OF PREFERRED EMBODIMENTS

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall(?) within the amabit (?) of the appended claims.

Embodiments of the present invention will be described below with reference to the accompanying drawings.

First Embodiment

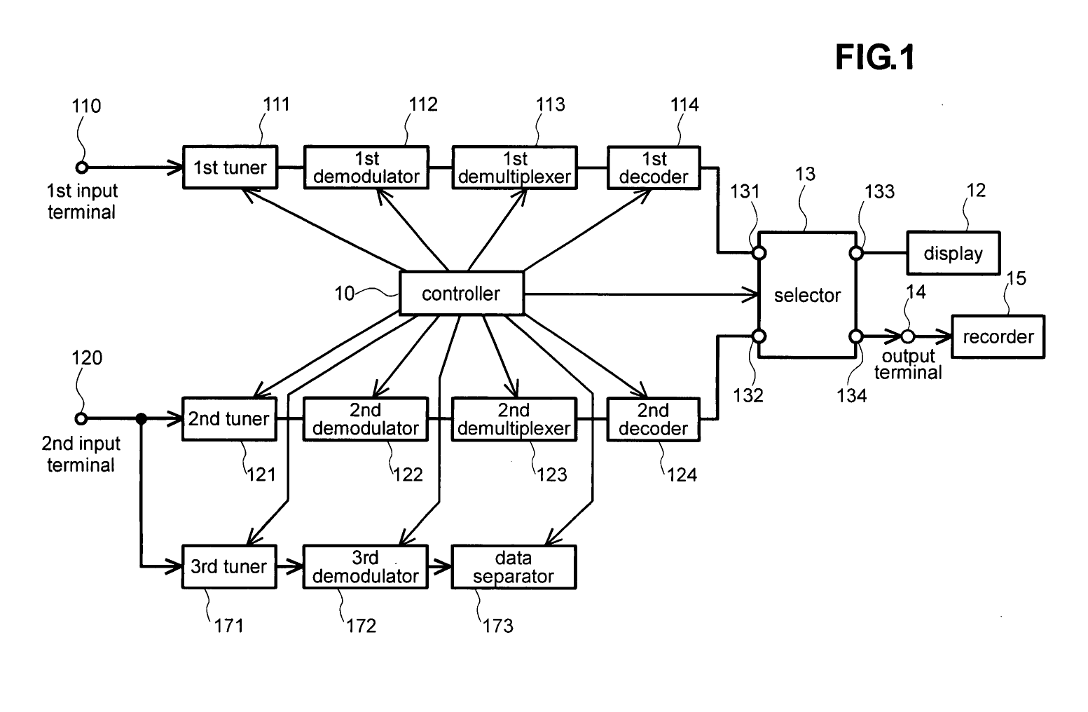

FIG. 1 shows an embodiment of the present invention and is a block diagram including a receiving apparatus of the present invention. Referring to FIG. 1, reference numeral 10 denotes a controller, 13 denotes a selector, 12 denotes a video display, 14 denotes a video-audio output terminal, and 15 denotes a recorder. Selector 13 has first input 131, second input 132, first output 133, and second output 134. First receiving system is made up of first input terminal 110, first tuner 111, first demodulator 112, first demultiplexer 113, and first decoder 114. Second receiving system is made up of second input terminal 120, second tuner 121, second demodulator 122, second demultiplexer 123, and second decoder 124. Further, third receiving system is made up of third tuner 171, third demodulator 172, and data separator 173.

On the transmission side, the logic channel composed of video, audio, and subsidiary data is encoded with use of such an encoding system as MPEG (Moving Picture Experts Group) and one or a plurality of encoded logic channels are multiplexed by using the MPEG system. Thus, a multiplexed encoded signal to be transmitted over one physical channel is obtained. The multiplexed encoded signal is modulated with use of a digital modulation system to become physical channel modulated signals to be transmitted over a physical channel employing different frequencies and the signals are input to input terminals 110 and 120 in FIG. 1.

Information about an emergency broadcast is transmitted with use of a channel called OOB (Out Of Band) as specified in SCTE 18 2001: Emergency Alert Message for Cable. In the OOB, there is included scramble information for the encoded signal and there are employed a modulation system and a physical channel different from those for the encoded signal. In the standards SCTE 18 2001, it is specified that, when it is detected that an emergency broadcast is being made, the related emergency broadcast channel must be displayed. Accordingly, if the physical channel of the emergency broadcast channel is different from the logic channel that has so far been watched, it is a matter of course that the tuned physical channel should also be changed.

We now return to the explanation of the receiving apparatus shown in FIG. 1. First, in the first receiving system, a received signal is tuned, demodulated, demultiplexed, and decoded. More specifically, tuner 111 tunes a signal of an arbitrary physical channel out of a modulated signal input to input terminal 110. The tuned modulated signal is demodulated by demodulator 112 and the demodulated signal is input to demultiplexer 113. Demultiplexer 113 separates a desired logic channel and inputs it to decoder 114. The decoder decodes the video and audio signals and the thus decoded video and audio signals are input to input terminal 131 of the selector. Such receiving operations are controlled by controller 10.

In the second receiving system, i.e., in second tuner 121, second demodulator 122, second demultiplexer 123, and second decoder 124, an input signal to input terminal 120 is tuned, demodulated, demultiplexed, and decoded the same as in the above described first receiving system. The demodulated video and audio signals are input to input terminal 132 of the selector.

The third receiving system is made up of third tuner 171, third demodulator 172, and data separator 173. A modulated signal from input terminal 120 is fed to tuner 171 and an OOB channel is tuned by tuner 171, the obtained signal is demodulated by demodulator 172, emergency broadcast information is separated from the obtained signal by data separator 173 and, thereby, it is detected whether an emergency broadcast is present or not. Incidentally, the third receiving system is such that only extracts information about an emergency broadcast and detects whether or not it is present. The emergency broadcast itself is received by the first or second receiving system.

TABLE 1

| | Displayed and | 131 | 132 | 133 | 134 |
|---|---|---|---|---|---|
| No. | Recorded Conditions | 1st Input | 2nd Input | 1st Output | 2nd Output |
| 1-1 | One normal ch. received. | ch. A | — | ch. A | — |
| 1-2 | Not displayed, but recorded outside. | ch. A | — | — | ch. A |
| 1-3 | Channel displayed and also recorded. | ch. A | — | ch. A | ch. A |
| 1-4 | One ch. displayed; the other oh. recorded | ch. A | ch. B | ch. A | ch. B |
| 2-1 | When emergency broadc. received (1) | ch. C | — | ch. C | — |
| | (while one normal ch. is being received) | ch. A | ch. C | ch. C | ch. A |
| 2-2 | When emergenoy broadc. is received (2) | | | | |
| | (while recording is being made) | | | | |
| 2-3 | When emergenoy broadc. is received (3) | ch. C | ch. B | ch. C | ch. B |
| | (while the other ch. is being recorded) | | | | |

Operation of selector 13 will be described with reference to Table 1. Table 1 shows displayed and recorded conditions of received channels and input to and output from selector 13. Here, it is assumed that channels A and B are channels arbitrarily selected by the user and channel C is an emergency broadcast channel to be forcedly displayed.

First, conditions in a normal state where there is present no emergency broadcast will be described. In a case where only channel 1 is received and it is not recorded by recorder 15, channel A is received by the first receiving system and the received signal is displayed by display 12. Accordingly, as shown in No. 1-1 of Table 1, the signal of input channel A from the first receiving system is fed to output 133. The second receiving system is not required to make any signal reception and output 134 for output terminal 14 is stopped.

Then, a case where only recording is performed in recorder 15 and no display is required will be considered. In such a case, as shown in No. 1-2 of Table 1, output 133 for display 12 is stopped and the signal of channel A received by the first receiving system is fed to output 134 for output terminal 14.

Then, when display and recording of the same channel are performed simultaneously, as shown in No. 1-3 of Table 1, signals of channel A received by the first receiving system are fed to output 133 for display 12 and to output 134 for output terminal 14.

Finally, when a displayed channel and a recorded channel are different, as shown in No. 1-4 of Table 1, the signal of input channel A from the first receiving system is fed to output 133 and the signal of channel B received by the second receiving system is fed to output 134 for output terminal 14.

There has so far been described the control executed in a normal state in which any emergency broadcast is made. If it is detected in data separator 173 that an emergency broadcast is being made, emergency broadcast channel C must be displayed on display 12. Further, when the emergency broadcast is started, information of the emergency broadcast channel that must be forcedly displayed is also extracted by data separator 173.

When an emergency broadcast is detected in the state of No.1-1 of Table 1, the first receiving system tunes in to channel C as shown in No. 2-1, and accordingly, input 131 and output 133 of selector 13 are turned into signals of channel C.

Then, when an emergency broadcast is detected in the state of No. 1-2 of Table 1, if channel C is received by the first receiving system, output 134 is also switched to the signal of channel C. Hence, recorder 15 becomes unable to record the signal of channel A, the signal originally intended to record. To prevent this, controller 10 in the present invention performs control such that channel A is continuously received by the first receiving unit, whereas emergency broadcast channel C is received by the second receiving system. At this time, as shown in No. 2-2 of Table 1, the signal of emergency broadcast channel C started to be received by the second receiving system is fed to input 132, while selector 13 feeds the signal of channel C to output 133 for display 12. In other words, it is surveyed or detected whether or not recording is being made by the recorder, and if the recording is being made by the recorder, the operation of receiving the emergency broadcast by the second receiving system and the switching operation by selector 13 are performed accordingly.

Also when an emergency broadcast is detected in the state shown in No. 1-3 of Table 1, while channel A is continuously received by the first receiving system, the emergency broadcast channel C is received by the second receiving system as shown in No. 2-2 of Table 1.

Finally, when an emergency broadcast is detected in the state of No. 1-4 of Table 1, the second receiving system which has so far been functioning for the recording is allowed to continue its signal reception and the first receiving system which has so far been functioning for the displaying is switched to receive the emergency broadcast channel. More particularly, as shown in No. 2-3 of Table 1, the first receiving system is switched from channel A to channel C and its signal is fed to input 131, whereupon selector 13 feeds the signal of channel C to output 133 for display 12. The signal of channel B is fed from output 134 to output terminal 14 the same as before the start of the emergency broadcast.

According to the present invention, as described above, when recording is being performed by recorder 15, the reception of the channel which has so far been recorded can be continued even after the emergency broadcast is started and, thus, recording of the channel intended to record by the user can be recorded without being interrupted.

Further, although not included in Table 1, if the channel having been displayed by display 12 is arranged to be recorded by recorder 15, instead of the channel having been recorded by recorder 15, before the emergency broadcast was started, the channel having been watched can be recorded completely.

The above description has been made on the precondition that the system is such that transmits emergency broadcast information with OOB. Another system is also conceivable in which emergency broadcast information is transmitted not with OOB but with an ordinary coded signal channel. In such a case, the third receiving system becomes unnecessary and presence or absence of an emergency broadcast can be detected by having the related table or flag extracted in demultiplexing unit 113 or 114 and having it monitored by controller 10.

Second Embodiment

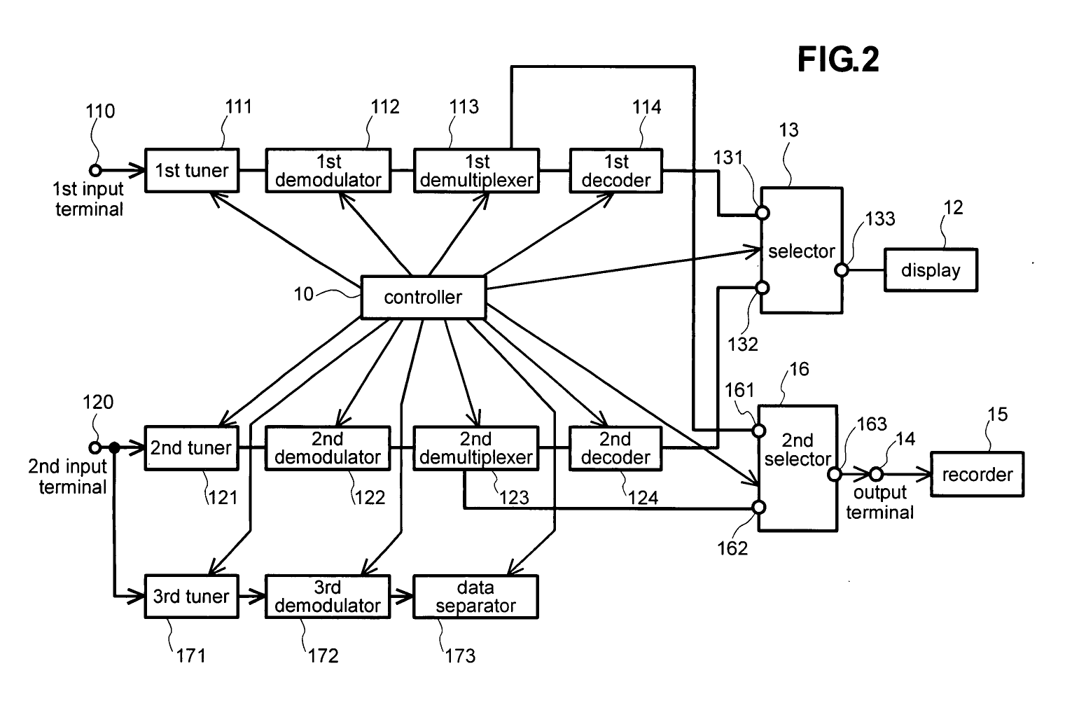

In the first embodiment, a signal decoded by decoder 114 or 124 is fed to recorder 15. However, when recorder 15 is of a type performing digital recording, such a configuration can also be made in which a demultiplexed signal, before being decoded, is fed to recorder 15. FIG. 2 shows a second embodiment of the present invention in which a demultiplexed signal is recorded. Selector 13 has only one output 133 to be fed only to display 12. Second selector 16 has inputs 161, 162 and output 163 and is adapted such that a demultiplexed signal by first demultiplexer 113 is fed to input 161, while a demultiplexed signal by second demultiplexer 123 is fed to input 162, and one of those signals is fed to output 163. Reference numerals corresponding to those in FIG. 1 denote corresponding elements.

Functions of selectors 13, 16 are basically the same as given in Table 1. However, inputs 161, 162 of selector 16 correspond to inputs 131, 132 of selector 13 and the signals at input 161, 162 are the signals obtained in each of the channels before being decoded. Output 163 corresponds to output 134 in Table 1.

First, conditions in a normal state where there is present no emergency broadcast will be explained. In the conditions corresponding to No. 1-1 of Table 1, a decoded signal of input channel A from the first receiving system is fed to output 133, while the second receiving system does not function. In the conditions corresponding to No. 1-2 of Table 1, output 133 for display 12 is stopped and a demultiplexed signal of channel A is fed to output 163 for output terminal 14. In the conditions corresponding to No. 1-3 of Table 1, a decoded signal of channel A received by the first receiving system is fed to output 133 and a demultiplexed signal of the same channel is fed to output 163. In the conditions corresponding to No. 1-4 of Table 1, a decoded signal of input channel A is fed to output 133 and a demultiplexed signal of channel B received by the second receiving system is fed to output 163.

If an emergency broadcast is detected, channel C must be displayed on display 12 the same as in the case of FIG. 1. When an emergency broadcast has been detected in the conditions corresponding to No. 1-1 of Table 1, the first receiving system tunes in to channel C the same as in No. 2-1 of Table 1, and accordingly input 131 and output 133 of selector 13 are turned into the signal of channel C.

Then, when an emergency broadcast has been detected in the conditions corresponding to No. 1-2 of Table 1, controller 10 controls such that, while channel A is continuously received by the first receiving system, emergency broadcast channel C is received by the second receiving system. At this time, as in No. 2-2 of Table 1, a demultiplexed signal of channel A being received by the first receiving system is fed to input 161 and delivered from output 163. At the same time, the decoded signal of channel C started to be received by the second receiving system is fed to input 132 and delivered from output 133. Further, also when an emergency broadcast has been detected in the state given in No. 1-3 of Table 1, channel A is continuously received by the first receiving system, while emergency broadcast channel C is received by the second receiving system.

Finally, when an emergency broadcast has been detected in the state given in No. 1-4 of Table 1, the second receiving system functioning so far for recording continues its reception the same as before and the first receiving system functioning so far for displaying is switched to receive the emergency broadcast channel. More specifically, the same as in No. 2-3 of Table 1, the received channel in the first receiving system is switched from channel A to channel C and a decoded signal of channel C is fed to input 131 and delivered from output 133. The demultiplexed signal of channel B is delivered from output 163 to output terminal 14 the same as before the start of the emergency broadcast.

According to the present invention, as described above, when recording is being performed in recorder 15, the reception of the recorded channel can be continued even after the emergency broadcast is started and, thus, recording of the channel intended to record by the user can be recorded without being interrupted.

There are provided two decoders in the embodiment shown in FIG. 2. In the case where digital recording is performed, however, it is only one channel for displaying that is to be decoded. Therefore, such a system may be made in which the number of decoders is reduced to one and the demultiplexed signal fed to the recorder is suitably switch-selected.

In the description made above, there are provided input terminals 110 and 120 for the first receiving system and the second receiving system, respectively. However, such a receiving apparatus may be made in which only one input terminal is provided with the input configured to branch off within the receiving apparatus.

Third Embodiment

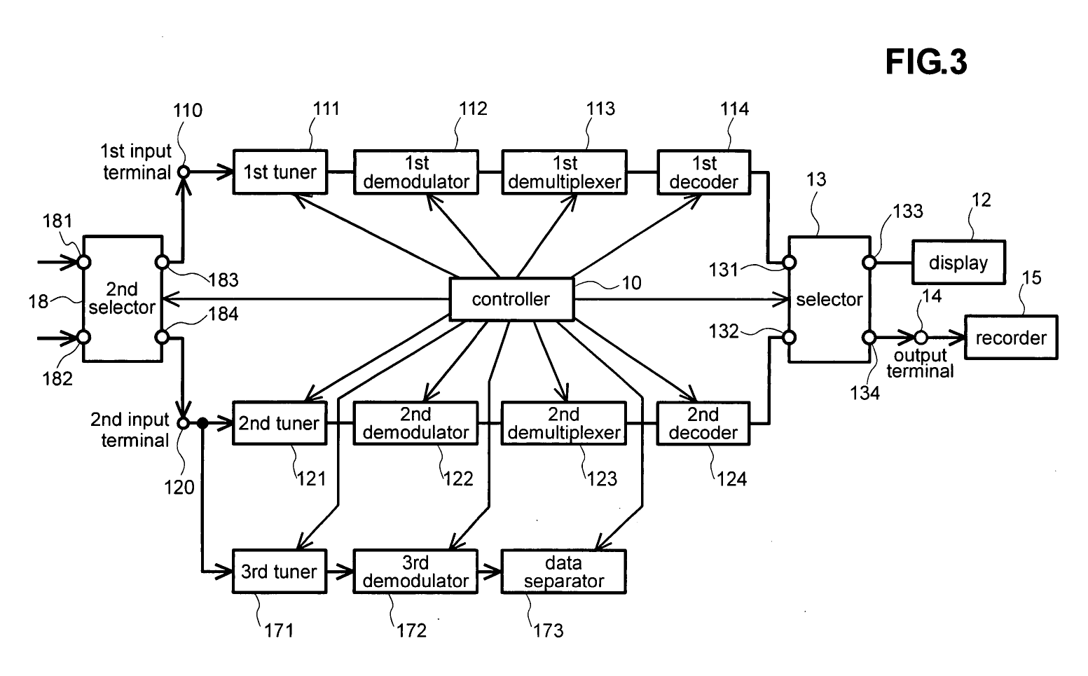

In the foregoing description, it is premised that the input signals to input terminals 110, 120 are identical. However, by providing a second selector in the preceding stage of input terminals 110, 120, the same effect can be obtained even if input signals are different. An embodiment in such a case will be shown in FIG. 3.

Referring to FIG. 3, reference numeral 18 denotes a second selector, 181 denotes a first input terminal, 182 denotes a second input terminal, 183 denotes a first output terminal, and 184 denotes a second output terminal. It is assumed that different signals are input to input terminals 181, 182.

For example, a signal from a terrestrial wave antenna is input to terminal 181 and a signal from a cable television network is input to terminal 182. One of the signals at terminals 181, 182 selected by controller 10 is fed to output terminal 183 and 184.

When the signals fed to output terminals 183, 184 are identical with each other, selector 18 does not need to be particularly controlled and, hence, the same operation as in the above described FIG. 1 may be made. In the case where the signals fed to output terminals 183 and 184 are input signals to terminals 181 and 182, respectively, and different from each other, selector 18 is controlled when an emergency broadcast is detected while recorder 15 is being operated.

Control of selector 18 will be described with reference to Table 1. In Table 1, we assume that channel A is a terrestrial wave signal and both channel B and channel C are cable signals. Hence, in the cases of conditions given in Nos. 1-1, 1-2, 1-3, and 1-4 of Table 1, selector 18 is controlled such that the terrestrial wave signal input to terminal 181 is fed to output terminal 183 and the cable signal input to terminal 182 is fed to output terminal 184.

In the case of conditions No.2-1, namely in the case where an emergency broadcast is detected while a normal channel is being received, the display must be switched to emergency broadcast channel C. Then, by controlling selector 18 such that the cable signal input to input terminal 182 is fed not only to output terminal 184 but also to output terminal 183, channel C becomes receivable by the first receiving system.

It is also possible to receive channel C by the second receiving system for displaying without controlling selector 18. In this case, the receiving system for displaying is switched from the first to the second receiving system.

In the case of conditions No.2-2, i.e., when the displayed channel is recorded, selector 18 does not need to be controlled because channel C is received by the second receiving system. Finally, in the case of conditions No. 2-3, i.e., when the other channel than the displayed channel is being recorded, channel C becomes receivable by the first receiving system by controlling selector 18 such that the cable signal input to terminal 182 is fed not only to terminal 184 but also to terminal 183, the same as in the case of conditions 2-1.

According to the present invention, as described above, even when different signals such as terrestrial wave signal and cable signal are input, the reception of the channel being recorded can be continued whether an emergency broadcast is started or not. Thus, recording of the channel intended to record by the user can be recorded without being interrupted.

In any of the embodiments described above, the receiving apparatus of the present invention, while continuing the reception of a channel being recorded, can newly receive and display an emergency broadcast channel with use of another receiving system. The receiving apparatus, while receiving and displaying an emergency broadcast channel, is capable of continuously recording the channel intended to record by the user without interruption. Thus, a receiving apparatus providing improved operability to the user can be realized.

1. A receiving apparatus comprising:
a first receiver and a second receiver for receiving physical channels;
a first output unit and a second output unit each for outputting one of the physical channels received by the first receiver and the second receiver;
a detector for detecting presence of an emergency broadcast; and
a controller, when an emergency broadcast is detected by the detector, controlling the first receiver and the first output unit such that the physical channel over which the emergency broadcast is broadcast is received by the first receiver and output from the first output unit and controlling the second receiver and the second output unit such that one of the first physical channel having been received by the first receiver and the second physical channel having been received by the second receiver before the emergency broadcast was detected is received by the second receiver and output from the second output unit.

2. The receiving apparatus according to claim 1, wherein the detector is a third receiver for receiving information about an emergency broadcast.

3. The receiving apparatus according to claim 2, wherein the third receiver receives a signal of a cable broadcast identical to that received by one of the first receiver and the second receiver.

4. The receiving apparatus according to claim 1, wherein the first output unit feeds a signal to a display displaying video and the second output unit feeds a signal to a recorder recording video.

5. The receiving apparatus according to claim 1, wherein
the first receiver includes a first tuner for tuning in to a received signal, a first demodulator for demodulating the tuned signal by the first tuner, a first demultiplexer for demultiplexing the demodulated signal by the first demodulator, and a first decoder for decoding the demultiplexed signal by the first demultiplexer, and
the second receiver includes a second tuner for tuning in to a received signal, a second demodulator for demodulating the tuned signal by the second tuner, a second demultiplexer for demultiplexing the demodulated signal by the second demodulator, and a second decoder for decoding the demultiplexed signal by the second demultiplexer.

6. The receiving apparatus according to claim 4, wherein the controller detects whether the output from the second output unit is being recorded by the recorder and, when the recording is being made by the recorder, controls such that the first receiver receives the physical channel on which the emergency broadcast is broadcast and the second receiver continues the reception of the physical channel being recorded by the recorder.

7. The receiving apparatus according to claim 5, wherein
one of the outputs of the first decoder and the second decoder is fed from the first output unit to a display, and
one of the outputs of the first demultiplexer and the second demultiplexer is fed from the second output unit to a recorder.

8. The receiving apparatus according to claim 1, further comprising a selector receiving a plurality of signals on different systems and outputting switch-selected signals of the received signals, wherein
the output of the selector is fed to one of the first receiver and the second receiver.

9. The receiving apparatus according to claim 8, wherein the input signals to the selector comprise a terrestrial wave signal and a cable broadcast signal.

10. The receiving apparatus according to claim 4, wherein, when an emergency broadcast is detected by the detector, the controller controls the second receiver and the second output unit such that a physical channel signal having been output from the second output unit before the emergency broadcast was detected is received by the second receiver and put out from the second output unit.

11. A displaying apparatus comprising:
a first receiver and a second receiver for receiving physical channels;
a display for displaying a signal of one of the channels received by the first receiver and the second receiver;
an output unit for outputting a signal of one of the channels received by the first receiver and the second receiver;
a detector for detecting presence of an emergency broadcast; and
a controller, when an emergency broadcast is detected by the detector, controlling the first receiver such that the physical channel over which the emergency broadcast is broadcast is received by the first receiver and the emergency broadcast is displayed by the display and controlling the second receiver and the output unit such that one of the first physical channel having been received by the first receiver and the second physical channel having been received by the second receiver before the emergency broadcast was detected is received by the second receiver and its signal is put out from the output unit.

12. The displaying apparatus according to claim 11, wherein, when an emergency broadcast is detected by the detector, the controller controls the second receiver and the output unit such that a physical channel signal having been output from the second detector before the emergency broadcast was detected is received by the second receiver and put out from the output unit.

13. A recording apparatus comprising:
a first receiver and a second receiver for receiving physical channels;
an output unit for outputting a signal of one of the channels received by the first receiver and the second receiver to a display;
a recorder for recording a signal of one of the channels received by the first receiver and the second receiver;
a detector for detecting presence of an emergency broadcast; and
a controller, when an emergency broadcast is detected by the detector, controlling the first receiver and the output unit such that the physical channel over which the emergency broadcast is broadcast is received by the first receiver and the emergency broadcast is output by the output unit and controlling the second receiver and the recorder such that one of the first physical channel having been received by the first receiver and the second physical channel having been received by the second receiver before the emergency broadcast was detected is received by the second receiver and its signal is recorded by the recorder.

14. The recording apparatus according to claim 13, wherein, when an emergency broadcast is detected by the detector, the controller controls the second receiver and the recorder such that a physical channel signal having been recorded by the recorder before the emergency broadcast was detected is received by the second receiver and recorded by the recorder.

15. The receiving apparatus according to claim 1, wherein each of the physical channels represents a channel of each of different frequencies.

16. The displaying apparatus of claim 11, wherein each of the physical channels represents a channel of each of different frequencies.

17. The recording apparatus of claim 13, wherein each of the physical channels represents a channel of each of different frequencies.
